(19) United States
(12) Patent Application Publication
(10) Pub. No.: US 2023/0226645 A1
(43) Pub. Date: Jul. 20, 2023

(54) CARRIER TAPE HOLE PROCESSING DEVICE USING LASER DRILLING

(71) Applicants: Wan Hae Choi, Daegu (KR); INNOPHOTONICS CORP., Gyeonggi-do (KR)

(72) Inventor: Wan Hae CHOI, Daegu (KR)

(73) Assignees: Wan Hae Choi, Daegu (KR); INNOPHOTONICS CORP., Gyeonggi-do (KR)

(21) Appl. No.: 18/126,185

(22) Filed: Mar. 24, 2023

Related U.S. Application Data
(63) Continuation of application No. PCT/KR2021/013265, filed on Sep. 28, 2021.

(30) Foreign Application Priority Data
Sep. 29, 2020 (KR) 10-2020-0127048

(51) Int. Cl. B23K 26/382; B23K 26/03; B23K 26/082; B23K 26/06

(52) U.S. Cl. CPC B23K 26/382; B23K 26/082; B23K 26/0344; B23K 26/0665

(57) ABSTRACT

A carrier tape hole processing device using laser drilling is provided. The carrier tape hole processing device includes a carrier tape formed in a band shape, a work unit configured to move the carrier tape while supporting the carrier tape, a laser drilling module disposed above the work unit and configured to irradiate a laser beam to the carrier tape placed on the work unit, a position recognition unit configured to detect a position and a moving speed of the carrier tape placed on the work unit, and a control unit configured to adjust a position of the laser beam irradiated by the laser drilling module. The control unit adjusts an irradiation position of the laser beam such that the laser beam follows the carrier tape according to the moving speed of the carrier tape detected by the position recognition unit.

### CROSS-REFERENCE TO RELATED APPLICATIONS

This application is a continuation of International Application No. PCT/KR2021/013265 filed Sep. 28, 2021, which claims priority to Korean Patent Application No. 10 2020 0127048 filed on Sep. 29, 2020, the entire contents of which are herein incorporated by reference.

### TECHNICAL FIELD

The present disclosure relates to a carrier tape hole processing device using laser drilling, and more particularly, to a carrier tape hole processing device using laser drilling capable of preventing a burr from occurring in holes of a carrier tape or the carrier tape from being torn, and uniformly forming the holes of the carrier tape by processing the holes of the carrier tape through laser drilling.

### BACKGROUND ART

Fine parts, such as integrated circuit (IC) chips, electric parts, and electronic parts, are produced while passing through a surface mounter technology (SMT) process. The fine parts, such as IC chips, electric parts, and electronic parts, may be disposed on a carrier tape having a band shape and including grooves therein and input to the SMT process, thereby increasing production efficiency.

Information detecting (ID) holes may be formed in the carrier tape to determine the presence of parts to be input to the SMT process or count the supply or production quantity of the parts. Meanwhile, in recent years, with the rapid development of semiconductor, electrical, and electronic package technologies, devices continue to become ultra-miniaturized, and accordingly, miniaturization of the ID holes formed in the carrier tape is also required.

Conventionally, ID holes are formed in a carrier tape through a pin-type method that punches with a pin, but the pin-type method has the following problems. When the ID holes are formed in the carrier tape through the pin-type method, there is a problem in that a bur may occur in the ID hole of the carrier tape and the ID holes are not uniformly formed.

In addition, when the ID holes are formed in the carrier tape through the pin-type method, there is a problem in that tearing occurs around the ID hole as the carrier tape is reduced in thickness. In addition, in the case of the pin-type method, since a large number of pins must be periodically replaced, there is a problem in that the time and costs required for maintenance increase and accordingly production volume decreases.

### SUMMARY

### Technical Problem

The present disclosure is for solving the above-described problems, and more particularly, relates to a carrier tape hole processing device using laser drilling capable of preventing a burr from occurring in holes of a carrier tape or the carrier tape from being torn, and uniformly forming the holes of the carrier tape by processing the holes of the carrier tape through laser drilling.

### Solution to Problem

One aspect of the present disclosure provides a carrier tape hole processing device using laser drilling including a carrier tape formed in a band shape, a work unit configured to move the carrier tape while supporting the carrier tape, a laser drilling module disposed above the work unit and configured to irradiate a laser beam to the carrier tape placed on the work unit, a position recognition unit configured to detect a position and a moving speed of the carrier tape placed on the work unit, and a control unit configured to adjust a position of the laser beam irradiated by the laser drilling module, wherein the control unit adjusts an irradiation position of the laser beam such that the laser beam follows the carrier tape according to the moving speed of the carrier tape detected by the position recognition unit.

The laser drilling module of the carrier tape hole processing device using laser drilling may include a variable focus unit configured to vary a focal length of the laser beam, an optical axis moving unit configured to emit the laser beam by being moved by a predetermined distance with respect to a reference optical axis, wherein the reference optical axis is an optical axis at a time point at which the laser beam passing through the variable focus unit is incident, and an optical axis driving unit configured to rotate the optical axis moving unit, wherein a hole may be formed by drilling a surface of the carrier tape while rotating the optical axis moving unit by the optical axis driving unit.

The optical axis moving unit of the carrier tape hole processing device using laser drilling may include a first wedge window configured to refract an incident laser beam, and a second wedge window disposed upside down with respect to the first wedge window to be spaced apart from the first wedge window.

A size of the hole formed on the surface of the carrier tape may be changed by adjusting a distance by which the laser beam is spaced apart from the reference optical axis while adjusting a separation distance between the first wedge window and the second wedge window of the carrier tape hole processing device using laser drilling.

The carrier tape hole processing device using laser drilling may further include a scanner unit including a mirror for reflecting the laser beam, wherein the control unit may adjust the irradiation position of the laser beam so that the laser beam follows the carrier tape by adjusting a position of the mirror according to the moving speed of the carrier tape detected by the position recognition unit.

The scanner unit of the carrier tape hole processing device using laser drilling may include a first mirror configured to reflect the laser beam, a first motor configured to rotate the first mirror, a second mirror configured to reflect the laser beam, and a second motor configured to rotate the second mirror, wherein the control unit may control positions of the first mirror and the second mirror by rotating the first motor and the second motor according to the moving speed of the carrier tape detected by the position recognition unit.

The carrier tape hole processing device using laser drilling may further include a focusing lens configured to focus the laser beam passing through the optical axis moving unit.

The control unit of the carrier tape hole processing device using laser drilling may change the irradiation position of the laser beam by changing a focal length of the laser beam using the variable focus unit.

### Advantageous Effects of Disclosure

The present disclosure relates to a carrier tape hole processing device using laser drilling, and there is an advantage of preventing a bur from occurring in holes of a carrier tape or the carrier tape from being torn by processing the holes of the carrier tape through laser drilling.

The present disclosure also has an advantage of preventing holes of a carrier tape from being non-uniformly formed by using a position recognition unit capable of detecting a position and a moving speed of the carrier tape and a control unit capable of adjusting an irradiation position of a laser beam so that the laser beam follows the carrier tape according to the moving speed of the carrier tape detected by the position recognition unit.

### BRIEF DESCRIPTION OF DRAWINGS

FIG. 1 is a view illustrating a carrier tape having holes formed therein according to an embodiment of the present disclosure.

FIG. 2 is an enlarged view of the carrier tape of FIG. 1.

FIG. 3 is a view illustrating a carrier tape hole processing device including a laser drilling module according to an embodiment of the present disclosure.

FIG. 4 is a view illustrating the laser drilling module according to an embodiment of the present disclosure.

FIG. 5 is a view illustrating a first wedge window and a second wedge window according to an embodiment of the present disclosure.

FIG. 6 is a view illustrating that the first wedge window and the second wedge window are rotated by 180° with respect to those of FIG. 4 by an optical axis driving unit.

FIG. 7 is a view illustrating a state in which a hole is formed in the carrier tape by rotation of an optical axis moving unit according to an embodiment of the present disclosure.

FIG. 8 is a view illustrating that a scanner unit capable of changing an irradiation position of a laser beam so that the laser beam is interlocked with a moving speed of the carrier tape is provided according to an embodiment of the present disclosure.

FIG. 9 is a view illustrating positions in which components of the laser drilling module are arranged in the carrier tape hole processing device according to an embodiment of the present disclosure.

FIG. 10 is a view illustrating a scanner unit according to an embodiment of the present disclosure.

FIG. 11 is a view illustrating that a first focusing lens and a second focusing lens are provided according to an embodiment of the present disclosure.

### DETAILED DESCRIPTION

Hereinafter, embodiments of the present disclosure will be described in detail with reference to the accompanying drawings. The embodiments of the present disclosure are provided to more completely explain the present disclosure to those having ordinary skill in the art. While the present disclosure is susceptible to various modifications and alternative forms, specific embodiments thereof are shown by way of example in the drawings and will herein be described in detail.

It should be understood, however, that there is no intent to limit the present disclosure to the particular forms disclosed, but on the contrary, the present disclosure is to cover all modifications, equivalents, and alternatives falling within the spirit and scope of the present disclosure. Similar reference numerals are used for similar elements in describing each drawing. In the accompanying drawings, dimensions of structures are exaggerated or deemphasized for the purpose of clarity of the present disclosure.

The terms used herein are for the purpose of describing particular embodiments only and are not intended to be limiting to the present disclosure. It is to be understood that the singular forms include plural forms unless the context clearly dictates otherwise. In the present specification, it will be further understood that the terms “comprise,” “comprising,” “include,” or “including” when used in this specification, specify the presence of stated features, integers, steps, operations, elements, components and/or groups thereof, but do not preclude the presence or addition of one or more other features, integers, steps, operations, elements, components and/or groups thereof.

Further, although terms such as “first,” “second,” and the like may be used to describe various elements, such elements should not be limited to the above terms These terms are only used to distinguish one element from another. For example, without departing from the scope of the present disclosure, a first element may be referred to as a second element, and similarly, a second element may be referred to as a first element.

When an element is referred to as being “connected” or “coupled” to another element, it is to be understood that the element may be directly connected or coupled to the another element, but there are other elements in between. On the other hand, when an element is referred to as being “directly connected to” or “directly coupled to” another element, it is to be understood that there is no new other elements between the element and the another element.

Unless otherwise defined, all terms used herein including technical or scientific terms have the same meanings as those generally understood by one of ordinary skill in the art Generally used terms defined in a dictionary should be interpreted to have meanings the same as meanings in the context of the related art and are not interpreted as ideal or excessively formal meanings unless the present disclosure clearly defines otherwise.

The present disclosure relates to a carrier tape hole processing device using laser drilling, and relates to a carrier tape hole processing device using laser drilling capable of preventing a burr from occurring in holes of a carrier tape or the carrier tape from being torn by processing the holes of the carrier tape through a laser drilling module.

The hole formed in the carrier tape according to an embodiment of the present disclosure may be an ID hole, but is not limited thereto, and may include various types of holes. Hereinafter, exemplary embodiments of the present disclosure will be described in detail with reference to the accompanying drawings.

The carrier tape hole processing device using laser drilling of the present disclosure includes a carrier tape 110, a work unit 120, a laser drilling module 200, a position recognition unit 130, and a control unit 140.

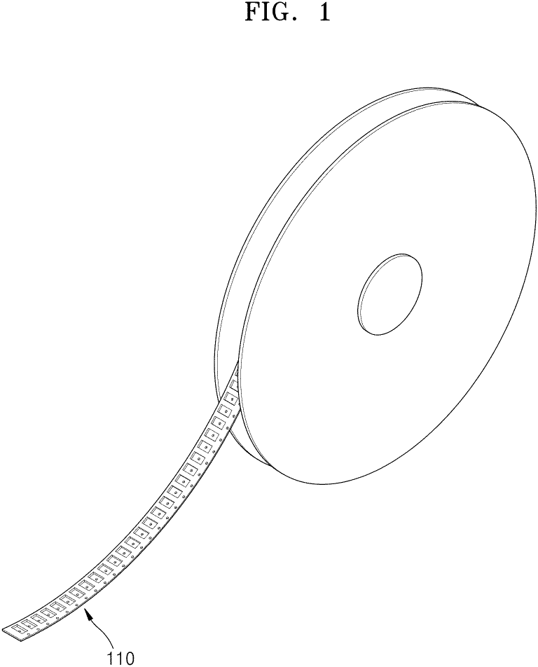

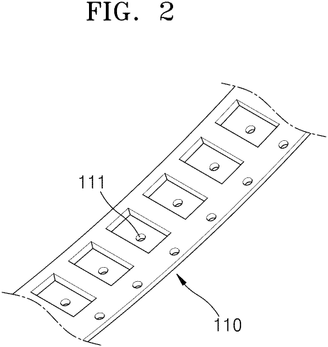

Referring to FIGS. 1 and 2, the carrier tape 110 may be formed in a band shape while extending in a length direction, and the carrier tape 110 may be used when fine parts such as integrated circuit (IC) chips, electric parts, electronic parts, or the like are input to a surface mounter technology (SMT) process.

The carrier tape 110 is formed in a band shape and has grooves formed therein, and the fine parts such as IC chips, electric parts, electronic parts, or the like may be mounted in the grooves and moved.

Holes 111 may be formed in the carrier tape 110. The holes 111 may be information detecting (ID) holes for determining whether there are parts input to an SMT process or counting the supply or production quantity of the parts, but is not limited thereto, and may have various types of holes.

The holes 111 of the carrier tape 110 may be formed through the laser drilling module 200 to be described later, and a method of forming the holes 111 in the carrier tape 110 through the laser drilling module 200 will be described later.

The work unit 120 may move the carrier tape 110 while the carrier tape 110 is placed thereon. The carrier tape 110 may be moved in one direction through the work unit 120 while having a specified speed.

The work unit 120 includes a guide rail 121 that moves together with the carrier tape 110 while the carrier tape 110 is placed thereon, and a winder 122 that moves the guide rail 121.

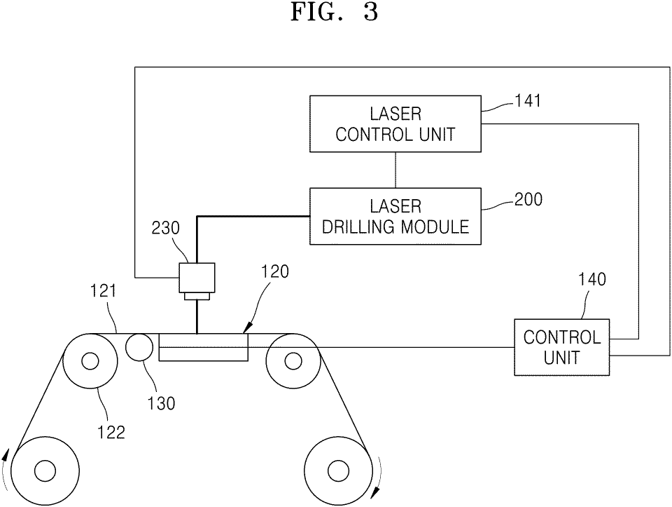

Referring to FIG. 3, a plurality of winders 122 may be provided, and the guide rail 121 may move while being wound around or unwound from the winder 122. When the guide rail 121 moves, the carrier tape 110 placed on the guide rail 121 is moved together therewith.

However, the work unit 120 is not limited thereto, and the work unit 120 may include various configurations as long as the carrier tape 110 can be moved in one direction at a specified speed.

Referring to FIG. 3, the laser drilling module 200 is disposed above the work unit 120, and thus a laser beam may be irradiated to the carrier tape 110 placed on the work unit 120.

The holes 111 may be formed in the carrier tape 110 by irradiating the carrier tape 110 with the laser beam through the laser drilling module 200. A detailed configuration of the laser drilling module 200 used to form the holes 111 in the carrier tape 110 will be described later.

Referring to FIG. 3, the position recognition unit 130 may detect a position and a moving speed of the carrier tape 110 placed on the work unit 120. The hole 111 formed in the carrier tape 110 must be formed at a specified position.

Accordingly, the hole 111 may be formed at the specified position of the carrier tape 110 only when a position at which the hole 111 is formed in the carrier tape 110 is recognized, and irradiated with the laser beam by the laser drilling module 200.

The position recognition unit 130 is provided for this, and the position recognition unit 130 detects the position of the carrier tape 110 and transmits a signal for adjusting an irradiation position of the laser beam irradiated from the laser drilling module 200 to the control unit 140.

The control unit 140 receives the signal of the position recognition unit 130, adjusts the irradiation position of the laser beam irradiated from the laser drilling module 200 according to the position of the carrier tape 110 detected by the position recognition unit 130, and forms the hole 111 at the specified position of the carrier tape 110.

The control unit 140 may adjust the irradiation position of the laser beam irradiated from the laser drilling module 200 by various methods, and the method of adjusting the irradiation position of the laser beam through the control unit 140 will be described later.

The position recognition unit 130 may also detect the moving speed of the carrier tape 110. As described above, the carrier tape 110 is moved through the guide rail 121 of the work unit 120 while being placed on the work unit 120.

When the holes 111 are formed in the carrier tape 110 through the laser beam irradiated from the laser drilling module 200, the holes 111 may be uniformly formed when the carrier tape 110 is stopped. However, there is a problem in that it is difficult to uniformly form the holes 111 in the carrier tape 110 through the laser beam as the carrier tape 110 moves in one direction while having a specified speed.

In order to solve the problem, the position recognition unit 130 may detect the moving speed of the carrier tape 110, and the moving speed of the carrier tape 110 detected by the position recognition unit 130 may be transmitted to the control unit 140.

The control unit 140 may adjust the position of the laser beam irradiated by the laser drilling module 200, and the control unit 140 may receive a signal of the moving speed of the carrier tape 110 transmitted from the position recognition unit 130.

The control unit 140 adjusts the irradiation position of the laser beam so that the laser beam follows the carrier tape 110 according to the moving speed of the carrier tape 110 detected by the position recognition unit 130.

That is, the control unit 140 may control the laser drilling module 200 so that the laser beam is irradiated by being synchronized with the moving speed of the carrier tape 110, and thus, the holes 111 may be uniformly formed through the laser beam even when the carrier tape 110 is moved in one direction.

The control unit 140 may further include a laser control unit 141 capable of controlling components of the laser drilling module 200, and the control unit 140 controls the laser control unit 141 through the signal related to the position and the moving speed of the carrier tape 110 transmitted from the position recognition unit 130. The laser control unit 141 adjusts the irradiation position of the laser beam by adjusting various components provided in the laser drilling module 200.

The position recognition unit 130 may be formed of an encoder to detect the position and the moving speed of the carrier tape 110. However, the present disclosure is not limited thereto, and the position recognition unit 130 may be formed of various types of sensors as long as the position and the moving speed of the carrier tape 110 can be detected.

The control unit 140 and the laser control unit 141 may form the holes 111 in the carrier tape 110 while synchronizing the laser beam with the moving speed of the carrier tape 110 by various methods, and the control unit 140 and the laser control unit 141 may use various configurations as long as they can adjust the irradiation position of the laser beam.

According to an embodiment of the present disclosure, the laser drilling module 200 irradiating a laser beam capable of forming the holes 111 in the carrier tape 110while synchronizing the laser beam with the moving speed of the carrier tape 110 may be configured with the following components.

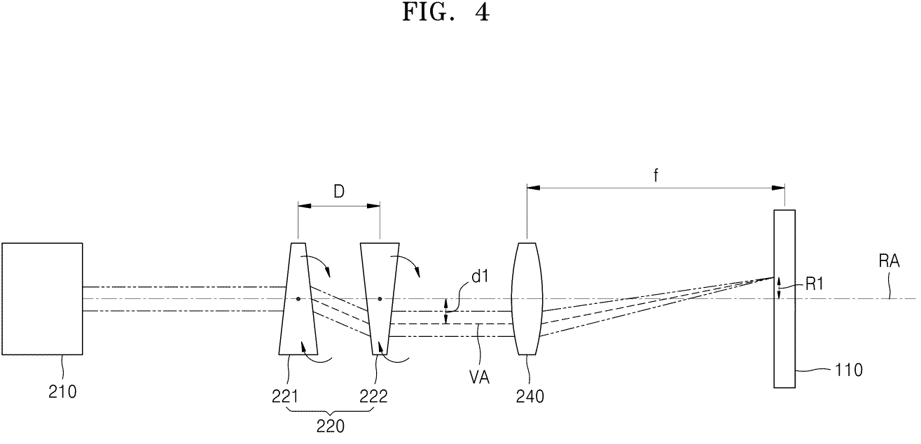

Referring to FIG. 4, the laser drilling module 200 includes a variable focus unit 210, an optical axis moving unit 220, and an optical axis driving unit.

The variable focus unit 210 may vary a focal length of a laser beam. The variable focus unit 210 may include a plurality of lenses having a variable distance therebetween. The focal length of the laser beam passing through the variable focus unit 210 may be varied by adjusting the distance between the lenses.

According to an embodiment of the present disclosure, the variable focus unit 210 may include a concave lens and a convex lens disposed side by side in an optical path direction of the laser beam and a moving module configured to move a position of the concave lens or the convex lens.

Accordingly, the focal length of the laser beam passing through the variable focus unit 210 may be adjusted by adjusting the distance between the concave lens and the convex lens. The laser beam passing through the variable focus unit 210 may travel in a parallel state, may be diverged, or may travel in a focused state. However, the present disclosure is not limited thereto, and the variable focus unit 210 may include various types of lenses as long as they can change the focal length of the laser beam.

When an optical axis at a time point at which the laser beam passing through the variable focus unit 210 is incident is referred to as a reference optical axis RA, the optical axis moving unit 220 is provided to emit the laser beam by being moved by a predetermined distance with respect to the reference optical axis RA. The laser beam is refracted while passing through the optical axis moving unit 220, and thus a travelling path of the laser beam is changed.

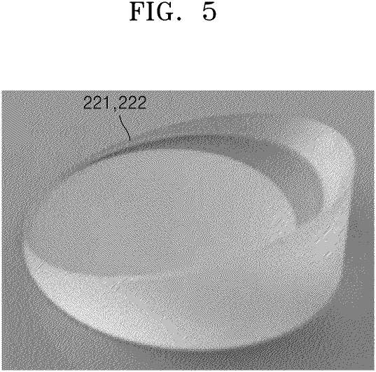

The optical axis moving unit 220 according to an embodiment of the present disclosure may include a first wedge window 221 and a second wedge window 222. Referring to FIGS. 4 and 5, the first wedge window 221 may refract an incident laser beam, and the laser beam is refracted downward by as much as a predetermined angle while passing through the first wedge window 221.

The second wedge window 222 is disposed to be spaced apart from the first wedge window 221, and is disposed upside down with respect to the first wedge window 221. That is, the second wedge window 222 is disposed in a line-symmetrical structure with respect to the first wedge window 221.

The laser beam passing through the first wedge window 221 is secondarily refracted by the second wedge window 222. An optical axis of the laser beam passing through the second wedge window 222 is moved in a state of being spaced apart from the reference optical axis RA by as much as a predetermined distance d1 as shown in FIG. 4, thereby changing the travelling path of the laser beam.

FIG. 4 illustrates a case in which the laser beam passing through the variable focus unit 210 travels horizontally, and the optical axis of the laser beam passing through the optical axis moving unit 220 is moved in parallel with the reference optical axis RA by as much as the predetermined distance d1.

A width of a two-dot chain line in FIG. 4 schematically illustrates a size of the laser beam, and the optical axis of the laser beam refracted while passing through the optical axis moving unit 220 is indicated by a dotted line.

Here, each of the first wedge window 221 and the second wedge window 222 may be formed in a shape as shown in FIG. 5. Each of the first wedge window 221 and the second wedge window 222 may have a trapezoidal cross section and may also have a triangular cross section.

Each of the first wedge window 221 and the second wedge window 222 may be formed in the form of a wedge window as shown in FIG. 5, but is not limited thereto, and may be formed of a prism.

When a distance between the first wedge window 221 and the second wedge window 222 is changed, a position of the optical axis of the laser beam is changed. Referring to FIG. 4, when a distance D between the first wedge window 221 and the second wedge window 222 increases, the distance d1 between an optical axis VA of the laser beam passing through the optical axis moving unit 220 and the reference optical axis RA increases, so that a position of the optical axis passing through a focusing lens 240 is changed.

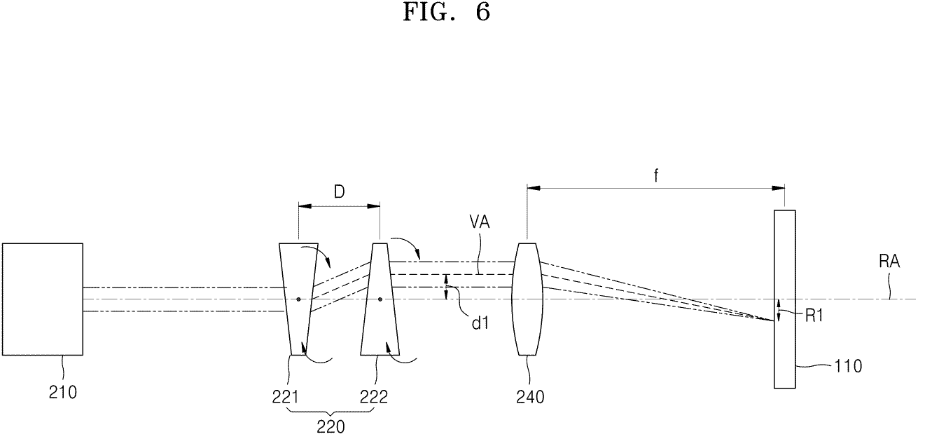

The optical axis driving unit is provided to rotate the optical axis moving unit 220. According to an embodiment of the present disclosure, the optical axis driving unit may rotate the optical axis moving unit 220 with the reference optical axis RA as a central axis. FIG. 6 illustrates a state in which the optical axis moving unit 220 is rotated by 180° through the optical axis driving unit.

As shown in FIG. 6, when the optical axis moving unit 220 is rotated by 180° by the optical axis driving unit, the optical axis VA of the laser beam passing through the second wedge window 222 is rotated half a circle about the reference optical axis RA and is positioned opposite to the position (the state of FIG. 4) before the optical axis moving unit 220 is rotated by 180°.

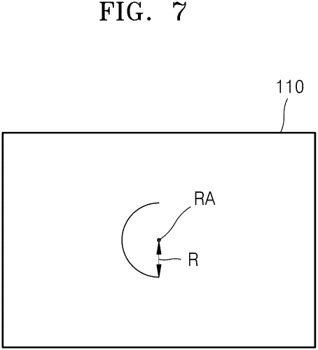

That is, the optical axis VA of the laser beam is rotated by 180° about the reference optical axis RA. FIG. 7 illustrates a state in which the optical axis VA of the laser beam is rotated by 180° and drilling is performed by a semicircle.

When the optical axis driving unit continuously rotates the optical axis moving unit 220, the optical axis VA of the laser beam is rotated about the reference optical axis RA, and the laser beam drills a surface of the carrier tape 110 while drawing a circle on the surface of the carrier tape 110.

When the distance between the first wedge window 221 and the second wedge window 222 is adjusted, the distance d1 by which the optical axis VA of the laser beam deviates from the reference optical axis RA may be adjusted. For example, when the distance between the first wedge window 221 and the second wedge window 222 is further increased, the optical axis VA of the laser beam moves further away from the reference optical axis RA.

Accordingly, as the distance between the laser beam and the reference optical axis RA increases, a hole formed in the carrier tape 110 may be processed to a large size. That is, when the optical axis of the laser beam is moved away from the reference optical axis RA and then the optical axis moving unit 220 is rotated by the optical axis driving unit, a hole whose radius is a distance from the reference optical axis RA to the optical axis of the laser beam may be processed on the surface of the carrier tape 110.

As described above, the carrier tape hole processing device using laser drilling according to an embodiment of the present disclosure may change the size of the hole formed on the surface of the carrier tape 110 by adjusting the distance to be moved with respect to the reference optical axis RA of the laser beam while adjusting a separation distance between the first wedge window 221 and the second wedge window 222.

Referring to FIGS. 4 to 6, the laser drilling module 200 according to an embodiment of the present disclosure may further include the focusing lens 240 configured to focus the laser beam passing through the optical axis moving unit 220. The focusing lens 240 is provided to focus the laser beam passing through the optical axis moving unit 220.

The focusing lens 240 forms a focus on the surface of the carrier tape 110 by refracting and focusing the laser beam passing through the optical axis moving unit 220. Since the focusing lens 240 adopts a known technique, a detailed description thereof will be omitted.

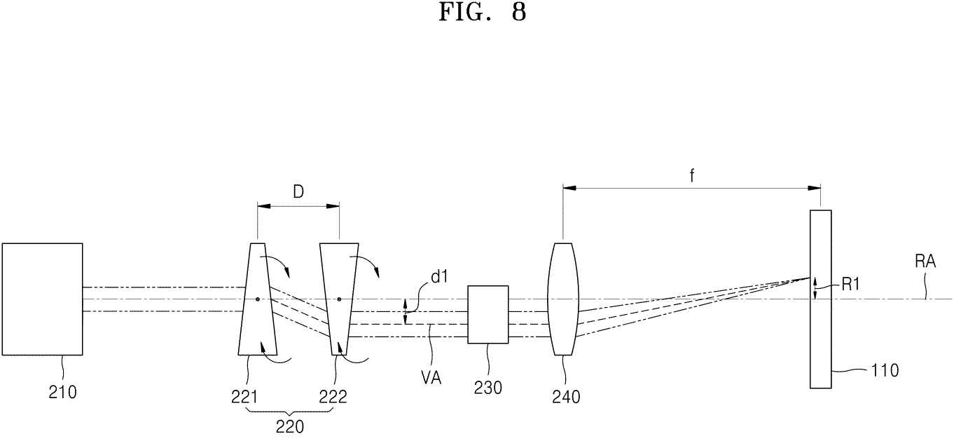

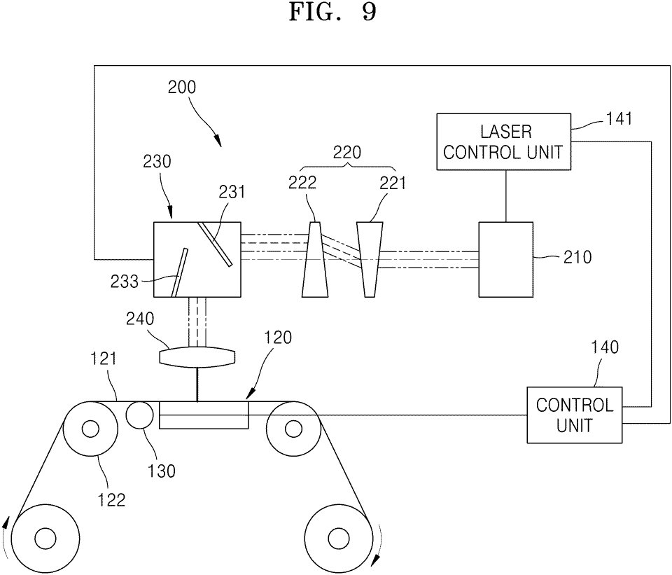

Referring to FIGS. 8 and 9, the carrier tape hole processing device using laser drilling according to an embodiment of the present disclosure may further include a scanner unit 230 including a mirror that reflects a laser beam.

As described above, as the optical axis moving unit 220 is rotated through the optical axis driving unit, the hole 111 may be formed in the carrier tape 110. Here, when the carrier tape 110 is in a stopped state, the holes 111 may be uniformly formed in the carrier tape 110 only by the rotation of the optical axis moving unit 220.

However, when the carrier tape 110 moves, there is a risk that the holes 111 formed in the carrier tape 110 are not uniformly formed due to the movement of the carrier tape 110.

In order to prevent this, the carrier tape hole processing device using laser drilling according to an embodiment of the present disclosure may include the scanner unit 230 including a mirror reflecting a laser beam.

The mirror may change a path of a laser beam by reflecting the laser beam, and when a position of the mirror is changed, the path of the laser beam may be changed. In order to uniformly form the holes 111 formed in the carrier tape 110, the control unit 140 may adjust the position of the mirror according to the moving speed of the carrier tape 110 detected by the position recognition unit 130.

Specifically, the control unit 140 adjusts the irradiation position of the laser beam so that the laser beam follows the carrier tape 110 by adjusting the position of the mirror. That is, as the position of the mirror is adjusted through the control unit 140, the laser beam may be irradiated while being interlocked with the moving speed of the carrier tape 110.

As long as the irradiation position of the laser beam can be adjusted so that the laser beam follows the carrier tape 110, various numbers and types of mirrors may be provided in the scanner unit 230.

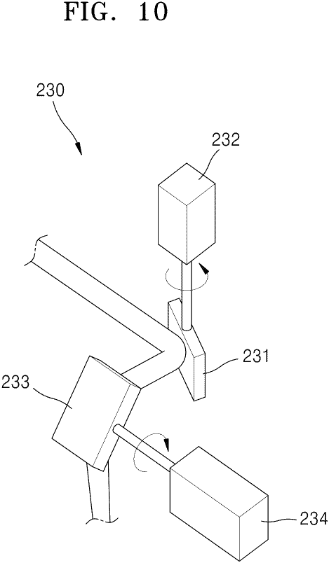

Referring to FIGS. 9 and 10, the scanner unit 230 may include a first mirror 231, a first motor 232, a second mirror 233, and a second motor 234. The first mirror 231 may reflect a laser beam, and the first motor 232 may rotate the first mirror 231.

The first mirror 231 is provided to move a laser beam in an X-axis direction, and may move the laser beam in the X-axis direction by rotating the first mirror 231 through the first motor 232.

The second mirror 233 may reflect a laser beam, and the second motor 234 may rotate the second mirror 233. The second mirror 233 is provided to move a laser beam in a Y-axis direction, and may move the laser beam in the Y-axis direction by rotating the second mirror 233 through the second motor 234.

The control unit 140 may adjust positions of the first mirror 231 and the second mirror 233 by rotating the first motor 232 and the second motor 234 according to the moving speed of the carrier tape 110 detected by the position recognition unit 130.

As the positions of the first mirror 231 and the second mirror 233 are adjusted through the control unit 140, the irradiation position of the laser beam may be changed in the X-axis direction and the Y-axis direction, thereby allowing the laser beam to be irradiated while being synchronized with the moving speed of the carrier tape 110.

In addition, as the irradiation position of the laser beam is changed in the X-axis and Y-axis directions by adjusting the positions of the first mirror 231 and the second mirror 233 through the control unit 140, the hole 111 may be formed at a specified position of the carrier tape 110.

However, the scanner unit 230 is not limited thereto, and various configurations may be used as long as the irradiation position of the laser beam can be adjusted to be interlocked with the moving speed of the carrier tape 110, or the irradiation position of the laser beam can be adjusted so that the laser beam is irradiated to the specified position of the carrier tape 110.

Referring to FIGS. 8 and 9, the scanner unit 230 may be provided between the optical axis moving unit 220 and the focusing lens 240.

As the optical axis moving unit 220 is rotated by the optical axis driving unit, a laser beam capable of forming the hole 111 of the carrier tape 110 may be irradiated. As the laser beam irradiated from the optical axis moving unit 220 passes through the scanner unit 230, the irradiation position may be changed so as to be interlocked with the moving speed of the carrier tape 110, and as the laser beam passing through the scanner unit 230 is focused through the focusing lens 240, the hole 111 is formed in the carrier tape 110.

FIGS. 4 to 7 illustrate a state in which a hole having a radius of R1 with respect to the reference optical axis RA is drilled on the surface of the carrier tape 110. When the optical axis moving unit 220 is rotated by the optical axis driving unit and the irradiation position is adjusted by the scanner unit 230, and then the laser beam is focused by the focusing lens 240, the hole 111 may be formed in the carrier tape 110 with a radius of R1.

According to an embodiment of the present disclosure, when a focal length of a laser beam is changed by the variable focus unit 210, a size of the hole 111 formed in the carrier tape 110 may be changed.

When the focal length of the laser beam is moved backward or forward by the variable focus unit 210, the focal length of the laser beam passing through the focusing lens 240 is changed accordingly, thereby changing the size of the hole 111 formed in the carrier tape 110.

In addition, according to an embodiment of the present disclosure, the control unit 140 may change an irradiation position of the laser beam by changing the focal length of the laser beam using the variable focus unit 210.

The control unit 140 may change the focal length of the laser beam using the variable focus unit 210 according to the moving speed of the carrier tape 110 detected by the position recognition unit 130, thereby allowing the laser beam to be irradiated so as to be interlocked with the moving speed of the carrier tape 110.

In addition, according to an embodiment of the present disclosure, the control unit 140 may change a size of the hole formed on the surface of the carrier tape 110 by adjusting a distance to be moved with respect to the reference optical axis RA of the laser beam while adjusting a separation distance between the first wedge window 221 and the second wedge window 222.

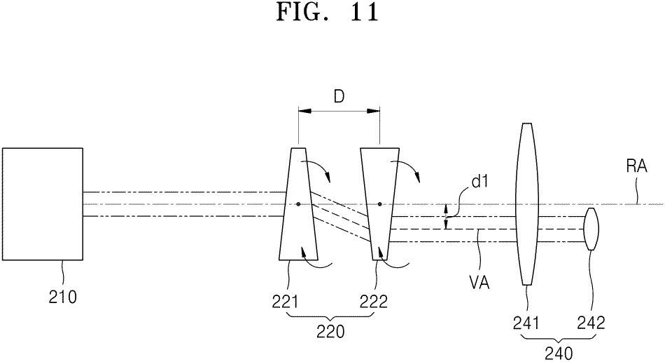

Referring to FIG. 11, the focusing lens 240 according to an embodiment of the present disclosure may include a plurality of focusing lenses. The focusing lens 240 may include a first focusing lens 241 and a second focusing lens 242.

Various types of focusing lenses may be used for the first focusing lens 241 and the second focusing lens 242, and the focal length of the laser beam passing through the scanner unit 230 may be changed according to the types of the first focusing lens 241 and the second focusing lens 242.

In addition, the second focusing lens 242 may be moved through the lens driving unit, and the focal length of the laser beam passing through the scanner unit 230 may be changed by moving the second focusing lens 242 through the lens driving unit.

The carrier tape hole processing device using laser drilling according to an embodiment of the present disclosure may operate as follows.

The control unit 140 may receive information on a position and a moving speed of the carrier tape 110 disposed in the work unit 120 through the position recognition unit 130. The control unit 140 transmits a signal received from the position recognition unit 130 to the laser control unit 141, and the laser control unit 141 adjusts a position of a laser beam irradiated from the laser drilling module 200 on the basis of the signal.

As the laser control unit 141 and the control unit 140 rotate the optical axis moving unit 220 through the optical axis driving unit, a circular-shaped laser beam capable of forming the hole 111 is irradiated to the carrier tape 110 At this point, the laser beam passing through the optical axis moving unit 220 is moved to the scanner unit 230.

The scanner unit 230 adjusts a position to which the laser beam is irradiated by calculating the moving speed of the carrier tape 110. Specifically, as the laser control unit 141 and the control unit 140 adjust positions of the mirrors (the first mirror 231 and the second mirror 233) through the motors (the first motor 232 and the second motor 234) provided in the scanner unit 230, the irradiation position of the laser beam is adjusted so as to be interlocked with the moving speed of the carrier tape 110.

When the irradiation position of the laser beam is adjusted to be interlocked with the moving speed of the carrier tape 110 by the scanner unit 230, the hole 111 is formed by focusing the laser beam through the focusing lens 240 and irradiating the laser beam to the surface of the carrier tape 110.

As described above, the carrier tape hole processing device using laser drilling according to an embodiment of the present disclosure irradiates the laser beam in conjunction with the moving speed of the carrier tape 110, so that the holes 111 may be uniformly formed in the carrier tape 110.

Here, the control unit 140 and the laser control unit 141 described above may be provided in one device or separated. In addition, the control unit 140 may also perform the role of the laser control unit 141.

The carrier tape hole processing device using laser drilling according to an embodiment of the present disclosure has the following effects.

The carrier tape hole processing device using laser drilling according to an embodiment of the present disclosure has an advantage of preventing a burr from occurring in holes of a carrier tape or preventing the carrier tape from being torn by processing the holes of the carrier tape through laser drilling.

In addition, the carrier tape hole processing device using laser drilling according to an embodiment of the present disclosure has an advantage of preventing holes of a carrier tape from being non-uniformly formed by using a position recognition unit capable of detecting a position and a moving speed of the carrier tape and a control unit capable of adjusting an irradiation position of the laser beam so that the laser beam follows the carrier tape according to the moving speed of the carrier tape detected by the position recognition unit.

As described above, the exemplary embodiments have been disclosed in the drawings and the specification. The embodiments have been described in the present specification by using specific terms, but this is only used for the purpose of describing the technical idea of the present disclosure and is not used to limit the scope of the disclosure described in the claims Therefore, those having ordinary skill in the technical field of the disclosure can understand that various modifications and equivalent other embodiments are possible from the embodiments.

### EXPLANATION OF REFERENCE NUMERALS DESIGNATING THE MAJOR ELEMENTS OF THE DRAWINGS

110: carrier tape, 111: hole
120: work unit, 121: guide rail
122: winder, 130: position recognition unit
140: control unit, 141: laser control unit
200: laser drilling module, 210: variable focus unit
220: optical axis moving unit, 221: first wedge window
222: second wedge window, 230: scanner unit
231: first mirror, 232: second mirror
233: first motor, 234: second motor
240: focusing lens, 241: first focusing lens
242: second focusing lens

1. A carrier tape hole processing device using laser drilling configured to process a hole of a carrier tape, the carrier tape hole processing device comprising:
a work unit configured to move the carrier tape while supporting the carrier tape;
a laser drilling module disposed above the work unit and configured to irradiate a laser beam to the carrier tape placed on the work unit;
a position recognition unit configured to detect a position and a moving speed of the carrier tape placed on the work unit; and
a control unit configured to adjust a position of the laser beam irradiated by the laser drilling module,
wherein the control unit adjusts an irradiation position of the laser beam such that the laser beam follows the carrier tape according to the moving speed of the carrier tape detected by the position recognition unit.

2. The carrier tape hole processing device of claim 1, wherein
the laser drilling module includes:
a variable focus unit configured to vary a focal length of the laser beam;
an optical axis moving unit configured to emit the laser beam by being moved by a predetermined distance with respect to a reference optical axis, wherein the reference optical axis is an optical axis at a time point at which the laser beam passing through the variable focus unit is incident; and
an optical axis driving unit configured to rotate the optical axis moving unit,
wherein a hole is formed by drilling a surface of the carrier tape while rotating the optical axis moving unit by the optical axis driving unit.

3. The carrier tape hole processing device of claim 2, wherein
the optical axis moving unit includes:
a first wedge window configured to refract an incident laser beam; and
a second wedge window disposed upside down with respect to the first wedge window to be spaced apart from the first wedge window.

4. The carrier tape hole processing device of claim 3, wherein a size of the hole formed on the surface of the carrier tape is changed by adjusting a distance by which the laser beam is spaced apart from the reference optical axis while adjusting a separation distance between the first wedge window and the second wedge window.

5. The carrier tape hole processing device of claim 1, further comprising a scanner unit including a mirror for reflecting the laser beam,
wherein the control unit adjusts the irradiation position of the laser beam such that the laser beam follows the carrier tape, by adjusting a position of the mirror according to the moving speed of the carrier tape detected by the position recognition unit.

6. The carrier tape hole processing device of claim 5, wherein the scanner unit includes a first mirror configured to reflect the laser beam, a first motor configured to rotate the first mirror, a second mirror configured to reflect the laser beam, and a second motor configured to rotate the second mirror,
wherein the control unit controls positions of the first mirror and the second mirror by rotating the first motor and the second motor according to the moving speed of the carrier tape detected by the position recognition unit.

7. The carrier tape hole processing device of claim 2, further comprising a focusing lens configured to focus the laser beam passing through the optical axis moving unit.

8. The carrier tape hole processing device of claim 2, wherein the control unit changes the irradiation position of the laser beam according to the change in a focal length of the laser beam by the variable focus unit.
